(19) United States
(12) Patent Application Publication
(10) Pub. No.: US 2026/0266019 A1
(43) Pub. Date: Sep. 10, 2026

(54) VENTILATION SYSTEM FOR AN ENCLOSURE OF A WORK MACHINE

(71) Applicant: Caterpillar Inc., Peoria, IL (US)

(72) Inventors: Jonathan Edward Seger, Bristol, IN (US); Daniel Allen Hatfield, Rochelle, IL (US); Anthony DeCarlo, Naperville, IL (US)

(73) Assignee: Caterpillar Inc., Peoria, IL (US)

(21) Appl. No.: 19/069,637

(22) Filed: Mar. 4, 2025

(51) Int. Cl. E02F 9/08

(52) U.S. Cl. CPC E02F 9/0866

(57) ABSTRACT

An enclosure for a battery of a work machine may include a first side wall having an inlet vent through the first side wall, a second side wall, a central wall, extending between the first side wall and the second side wall, having an outlet vent through the central wall, and an air-guiding cover over the outlet vent and defining an opening. The air-guiding cover may be configured to guide air that is to flow through the outlet vent to flow through the opening.

### TECHNICAL FIELD

The present disclosure relates generally to work machines and, for example, to ventilation system for an enclosure of a work machine.

### BACKGROUND

A work machine, such as a wheel loader, a dozer, an excavator, or the like, typically performs operations associated with industries such as mining, construction, farming, or transportation. An electric work machine may utilize batteries as a power source rather than an engine. The batteries are stored in an enclosure on the machine with other electronic components used to deliver power to an electric motor. The batteries can be rather large, with the enclosure sized accordingly. As a result, the enclosure may obstruct viewing angles from an operator station of the machine.

Moreover, the batteries and electronic components may generate a significant amount of heat. Thus, many electric work machines employ a cooling system (also referred to as a “cooling package”) to remove heat from the compartment. The cooling system itself is also bulky, and in many cases is fitted into the enclosure wherever there is sufficient space in order to avoid increasing the size of the enclosure. However, by doing so, the cooling system may have suboptimal thermal efficiency or air flow patterns. For example, in some arrangements, hot air expelled from the cooling system may be inadvertently recirculated into the enclosure, which can lead to overheating of the batteries and other electronic components.

The ventilation system of the present disclosure solves one or more of the problems set forth above and/or other problems in the art.

### SUMMARY

A work machine may include a frame, a battery positioned on the frame, and an enclosure connected to the frame and enclosing the battery. The enclosure may include a first side wall having an inlet vent through the first side wall, a second side wall, a central wall, extending between the first side wall and the second side wall, having an outlet vent through the central wall, an air-guiding cover over the outlet vent and defining an opening, and a cooling system mounted to the enclosure over the battery. The cooling system may be configured to draw air through the inlet vent and expel air through the outlet vent in a flow direction. The air-guiding cover may be configured to guide air that is to flow through the outlet vent in the flow direction to flow through the opening in a redirected flow direction.

An enclosure for a battery of a work machine may include a first side wall having an inlet vent through the first side wall, a second side wall, a central wall, extending between the first side wall and the second side wall, having an outlet vent through the central wall, and an air-guiding cover over the outlet vent and defining an opening. The air-guiding cover may be configured to guide air that is to flow through the outlet vent to flow through the opening.

A ventilation system for a power source of a work machine may include an enclosure configured to enclose the power source. The enclosure may include a wall having an outlet vent through the wall, and an air-guiding cover over the outlet vent and defining an opening. The ventilation system may include a cooling system mounted to the enclosure. The cooling system may be configured to draw air through an inlet vent in the enclosure and expel air through the outlet vent in a flow direction. The air-guiding cover may be configured to guide air that is to flow through the outlet vent in the flow direction to flow through the opening in a redirected flow direction.

### BRIEF DESCRIPTION OF THE DRAWINGS

FIG. 1 is a side view of an example machine.

FIG. 2 is a perspective view of an example of an enclosure.

FIG. 3 is a top view of an example of an enclosure.

FIG. 4 is a side view of an example of an enclosure.

FIG. 5 is a cross-sectional view, taken along line A-A of FIG. 3, of an example of an enclosure enclosing one or more cooling systems, a plurality of batteries, and/or one or more electronics systems.

### DETAILED DESCRIPTION

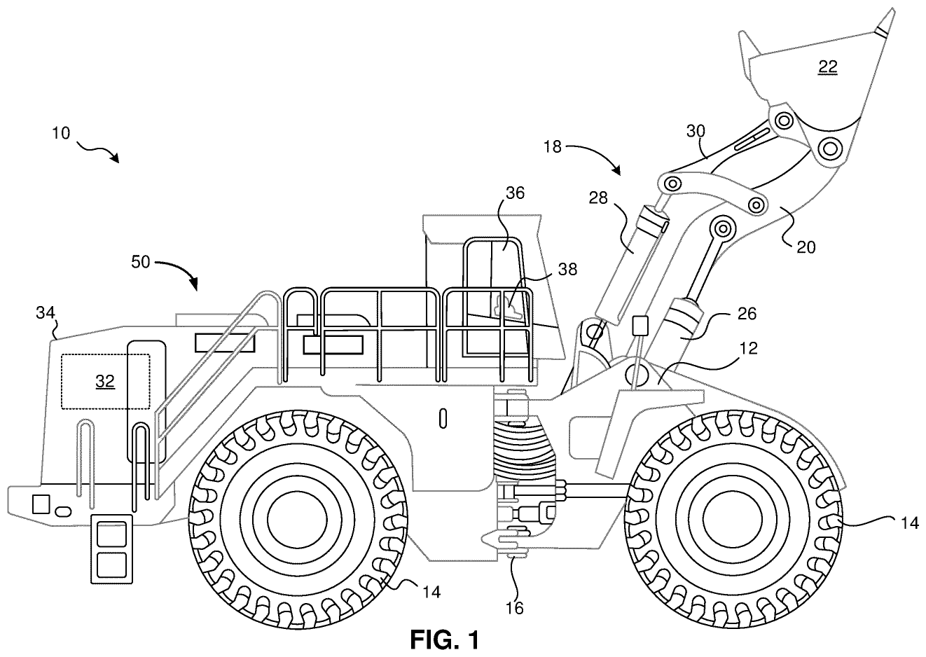

FIG. 1 is a side view of an example machine 10 (e.g., a work machine). FIG. 1 shows an example where the machine 10 is a wheel loader. However, the machine 10 may be another type of machine, such as an excavator, a dozer, a backhoe loader, a skid steer loader, a dump truck, a motor grader, a compactor, a paving machine, a cold planer, or the like.

The machine 10 includes a frame 12 that is supported by one or more traction elements 14 used to propel the machine 10 in a forward direction and/or a rearward direction. The traction elements 14 are configured to engage a ground surface, such as a road or another type of terrain. The traction elements 14 may include wheels (as shown), tracks, or a combination thereof. The frame 12 may include a front section and a rear section connected by an articulation joint 16 that allows the front section of the frame 12 to pivot about the articulation joint 16 relative to the rear section of the frame 12, thereby steering the machine 10. Additionally, or alternatively, the machine 10 may include another type of steering system, such as a rack and pinion mechanism or independent gear drives or motors associated with individual traction elements 14, among other examples.

The machine 10 includes a linkage assembly 18 movably coupled to the frame 12. The linkage assembly 18 includes a lift arm 20 movably coupled to the frame 12, and an implement 22 movably coupled to the lift arm 20. The implement 22 may be a bucket, as shown, or another type of implement capable of performing work operations such as loading, stock piling, dumping, or the like. The linkage assembly 18 also includes one or more actuators (e.g., hydraulic actuators) configured to provide movement of the linkage assembly 18. As shown, the linkage assembly 18 may include one or more lift actuators 26, connected to the frame 12 and the lift arm 20, that are configured to raise and lower the lift arm 20 relative to the frame 12. Furthermore, the linkage assembly 18 may include one or more tilt actuators 28 configured to tilt the implement 22. For example, the linkage assembly 18 may include a tilt linkage 30 that is pivotably connected to the tilt actuator(s) 28, the lift arm 20, and the implement 22 to enable tilting of the implement 22.

The machine 10 includes an enclosure 34 for a power source 32 of the machine 10. The enclosure 34 may be connected to the frame 12. The frame 12 supports the power source 32. The power source 32 may be an engine, such as a diesel engine, a gasoline engine, or a gaseous fuel engine (e.g., a natural gas engine), among other examples. Additionally, or alternatively, the power source 32 may be a fuel cell or an energy storage device (e.g., one or more batteries), among other examples. Here, the power source 32 may be coupled to one or more electric motors (not shown) of the machine 10. The power source 32 is configured to produce a mechanical and/or an electrical power output used to drive the traction devices 14, a steering system of the machine 10, and/or the linkage assembly 18. The power source may be positioned on the frame 12 and/or enclosed in the enclosure 34.

The frame 12 may support an operator station 36. The operator station 36 includes one or more controls 38, such as joysticks, pedals, levers, buttons, switches, knobs, touch screen controls, operator consoles, and/or a steering wheel, among other examples. The controls 38 enable an operator to control the machine 10 during operation. In some implementations, the machine 10 may be configured for remote controlled operation or autonomous operation.

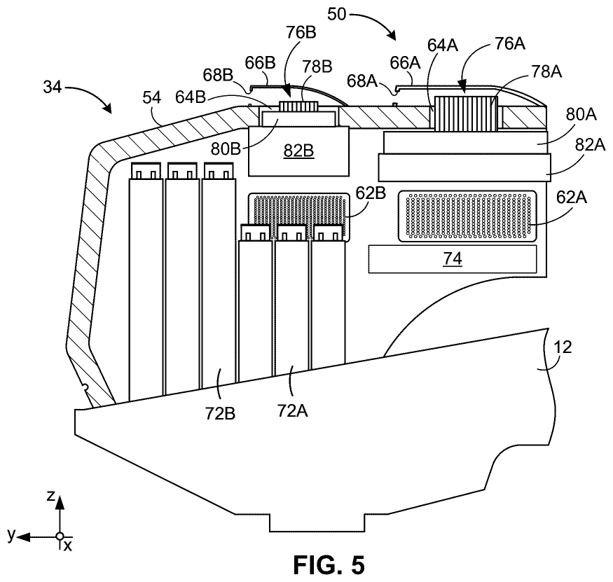

The machine 10 includes a ventilation system 50, which may include the enclosure 34 and at least one cooling system (as shown in FIG. 5) mounted to the enclosure 34. As described herein, the ventilation system 50 may be configured to redirect exhaust air flowing out from the enclosure 34 in a substantially vertical direction away from the enclosure 34 (e.g., which otherwise may be recirculated into the enclosure), to flow in a substantially horizontal direction along the enclosure 34, thereby reducing recirculation.

As indicated above, FIG. 1 is provided as an example. Other examples may differ from what is described with regard to FIG. 1.

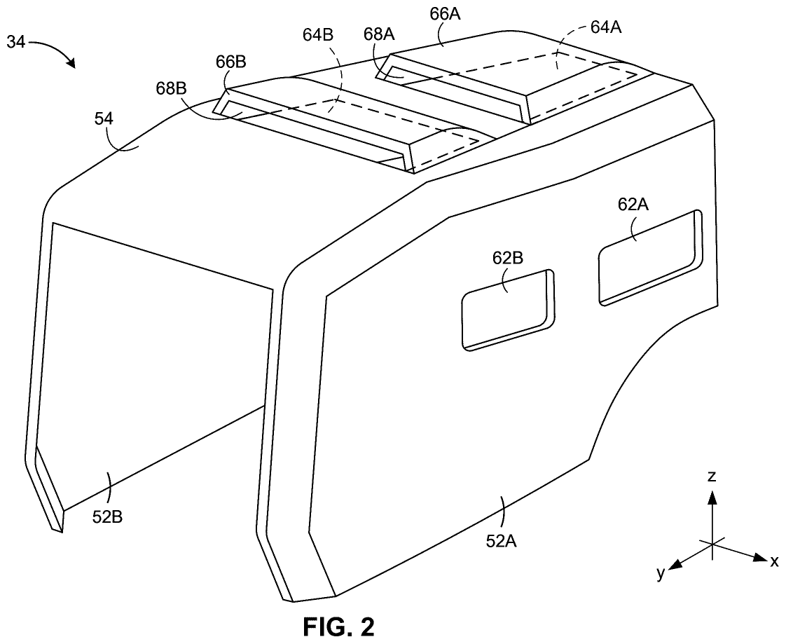

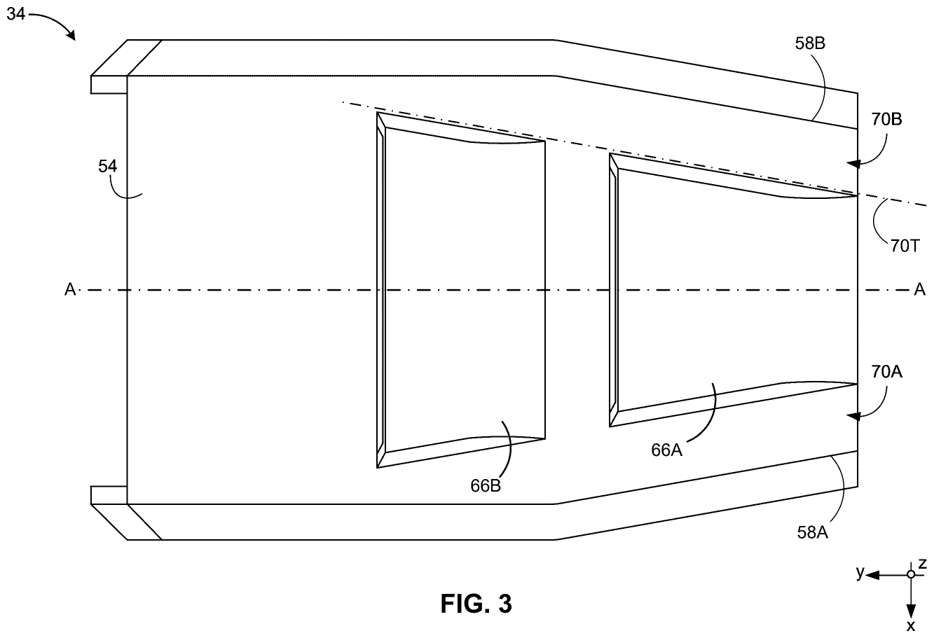

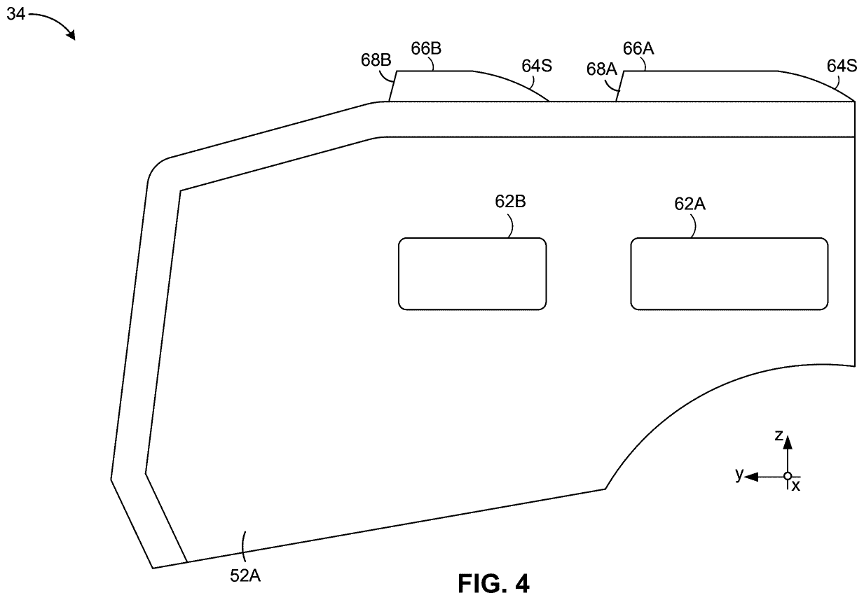

FIG. 2 is a perspective view of an example of the enclosure 34. FIG. 3 is a top view of an example of the enclosure 34. FIG. 4 is a side view of an example of the enclosure 34. The enclosure 34 includes a first side wall 52A and a second side wall 52B, and a central wall 54 extending between the first side wall 52A and the second side wall 52B.

The side walls 52 refer to enclosure portions extending in a vertical (or substantially vertical) direction (e.g., in the z-axis), encompassing at least a portion of the enclosure 34 in a vertical plane (e.g., in the z-y plane). In some implementations, the side walls 52 may include a planar, curved, or contoured surface. The central wall 54 refers to an enclosure portion extending between the first side wall 52A and the second side wall 52B in a horizontal (or substantially horizontal) direction (e.g., in the x-axis), encompassing at least a portion of the enclosure 34 in a horizontal plane (e.g., an x-y plane). In some implementations, the central wall 54 may include a planar, curved, or contoured surface. The side walls 52 may transition into the central wall 54 in a continuous manner (e.g., through a curved or smoothly contoured surface) or in a sharply distinct manner (e.g., through an angular junction or edge). For example, the side walls 52 and the central wall 54 may form a continuous U-shaped wall or a partial boxed-shape wall. Regardless of the particular contouring or angularity of the enclosure 34, the side walls 52 may define a first enclosure surface having a first normal vector, and the central wall 54 may define a second enclosure surface having a second normal vector being substantially different (e.g., equal to or greater than 90 degrees) from the first normal vector.

The first side wall 52A includes a first inlet vent 62A and/or a second inlet vent 62B through the first side wall 52A. The inlet vents 62A, 62B are openings through the enclosure 34 that fluidly connects the inside of the enclosure 34 with an outside environment of the enclosure 34. The inlet vents 62A, 62B are configured to allow air to flow into the enclosure 34 from the outside environment. The first inlet vent 62A and the second inlet vent 62B may be arranged at approximately equal heights in the first side wall 52A. Arranging the inlet vents 62A, 62B in the side walls 52 allow for closer positioning to heat generating-components in the enclosure 34 (e.g., batteries, electronics systems, etc.), thereby allowing for efficient heat removal. Although not shown, the second side wall 52B may have one or more inlet vents, similar to inlet vents 62A and/or 62B. In some implementations, the enclosure 34 may include more than two inlet vents per side wall.

The central wall 54 includes a first outlet vent 64A and/or a second outlet vent 64B through the central wall 54. The outlet vents 64A, 64B are openings through the enclosure 34 that fluidly connect the inside of the enclosure 34 with the outside environment of the enclosure 34. The outlet vents 64A, 64B are configured to allow air to flow from inside the enclosure 34 to the outside environment. Each outlet vent 64A, 64B may be horizontally aligned with a respective inlet vent 62A, 62B (e.g., along the y-axis). For example, a first cross-section of the enclosure 34 (e.g., taken in the z-x plane) may encompass the first inlet vent 62A and the first outlet vent 64A, and a second cross-section of the enclosure 34 (e.g., taken in the z-x plane) may encompass the second inlet vent 62B and the second outlet vent 64B. This alignment between the outlet vents 64A, 62B and the inlet vents 62A, 62B allows for efficient heat removal by creating a direct air path through the enclosure 34.

The enclosure 34 includes a first air-guiding cover 66A over the first outlet vent 66A defining a first opening 68A and/or a second air-guiding cover 66B over the second outlet vent 66B defining a second opening 68B. The covers 66A, 66B may be enclosure portions protruding from the central wall 54 that are shaped to guide air through the openings 68A, 68B, respectively. As discussed in greater detail below, the covers 66A, 66B are configured to guide air that is to flow through the outlet vents 64A, 64B in a flow direction (e.g., the z-axis) to flow through the openings 68A, 68B in a redirected flow direction (e.g., the y-axis). In some implementations, the openings 68A, 68B (e.g., extending in the z-x plane) have approximately (e.g., ±10°) perpendicular orientations to the outlet vents 64A, 64B (e.g., extending in the x-y plane). These different orientations facilitate the redirection of air flow expelled from the enclosure 34. The covers 66A, 66B also reduce the infiltration of liquids (e.g., rain water) into the enclosure 34 through the outlet vents 64A, 64B.

The first outlet vent 64A and the first cover 66A may be arranged in a line (e.g., from a front to a rear of the enclosure 34, such as in a direction of travel of the machine 10 or along the y-axis) with the second outlet vent 64B and the second cover 66B (e.g., such that the first opening 68A faces the second cover 66B). This can result in air expelled from the first outlet vent 64A flowing over and around the second cover 66B. In some implementations, the covers 66A, 66B have sloping portions 64S, shown in FIG. 4, opposite their openings 68A, 68B, which can reduce turbulence and promote linear flow, thereby compensating for the in-line arrangement of the first outlet vent 64A and the first cover 66A with the second outlet vent 64B and the second cover 66B. For example, the first cover 66A and the second cover 66B can be aligned such that air guided by the first cover 66A is to flow over the second cover 66B and combine with air guided by the second cover 66B. Therefore, the air guided by the first cover 66A does not undergo (or a reduced portion of the air undergoes) turbulence and/or recirculation of hot air by the second cover 66B, thereby enhancing cooling efficiency.

When air is redirected from flowing through the outlet vents 64A, 64B in the first direction to flowing through the openings 68A, 68B in the redirected flow direction, the inside surfaces of the slopping portions 64S can provide redirection of the air. Thus, the slopping portions 64S help improve air flow between the inside of the enclosure 34 and the outside environment of the enclosure 34 by redirecting the air towards the rear of the enclosure 34 (e.g., the rear of the machine 10), which reduces the amount of air flowing back into the enclosure 34 through the inlet vents 64A, 64B. The sloping portions 64S also reduce an overall profile of the covers 66A, 66B to provide cleaner sightlines from the operator station 36.

In some implementations, the covers 66A, 66B extend partially across the central wall 54 to leave a first sightline channel 70A and a second sightline channel 70B, as shown in FIG. 3. The first sightline channel 70A may be defined between the covers 66A, 66B and a first edge 58A of the central wall 54. The second sightline channel 70B may be defined between the covers 66A, 66B and a second edge 58B of the central wall 54. The partially extending covers 66A, 66B, not extending all the way across the central wall 54, provide sightlines from the operator station 36 that facilitate improved viewing, particularly looking rearward toward the enclosure 34 (e.g., the rear of the machine 10). In some implementations, the covers 66A, 66B may taper longitudinally (e.g., along the y-axis). The angle of tapering of the first cover 66A may be matched and continued at the second cover 66B, shown by line 70T. This tapering can follow the sightline channels 70A, 70B, thereby providing viewing angles from the operator station 36 while allowing for maximizing the width of the covers 66A, 66B.

In some implementations, the enclosure 34 may include a rear wall (not shown) extending from the central wall 54 and between the first side wall 52A and the second side wall 52B. In some implementations, the rear wall may include an inlet vent, in a similar manner as described herein.

As indicated above, FIGS. 2-4 are provided as an example. Other examples may differ from what is described with regard to FIGS. 2-4.

FIG. 5 is a cross-sectional view, taken along line A-A of FIG. 3, of an example of the enclosure 34 enclosing a first cooling system 76A and/or a second cooling system 76B, a plurality of batteries 72 (shown as a first battery 72A and a second battery 72B), and/or one or more electronics systems 74. As shown, the ventilation system 50 may include the enclosure 34 and the cooling systems 76A, 76B.

The batteries 72 may be any energy storage devices configured to supply electrical power for operation of various components of the machine 10. For example, the batteries 72 can be configured to provide energy to electric motors (not shown) of the machine 10 for propulsion, to a hydraulic system (not shown) of the machine 10, etc.

In some implementations, the first battery 72A and the second battery 72B may be positioned on the frame 12 in the same orientation, but such that the second battery 72B is elevated relative to the first battery 72A with respect to the enclosure 34. This arrangement of the batteries 72 makes room for the second inlet vent 62B and the second cooling system 76B, while maximizing battery storage. Furthermore, the arrangement of the batteries 72 defines an air gap between the batteries 72 and the second cooling system 76B, which improves thermal efficiency of the second cooling system 76B.

The electronics systems 74 may be connected to, and enclosed within, the enclosure 34. The electronics systems 74 may include any electronic component configured to control, monitor, and/or otherwise process outputs of the batteries 72. The electronics systems 74 can be electrically coupled to the batteries 72 to regulate energy flow through power electronics (e.g., such as inverters, converters, etc.). For example, the electronics system 74 can control the batteries 72 and power flow therefrom, and control various components of the machine 10 for propulsion, actuation of machine functions, or the like.

The cooling systems 76A, 76B may be connected to, and enclosed within, the enclosure 34. The second cooling system 76B may be mounted to the enclosure 34 over one or more of the batteries 72, and the first cooling system 76A may be mounted to the enclosure 34 over one or more of the electronics systems 74. The cooling systems 76A, 76B may be any cooling component configured to manage temperature of the batteries 72 and/or of the electronics systems 74. The cooling systems 76A, 76B may include a fan, a heat exchanger, and/or a chiller, among other examples. For example, the cooling system 76B may include a battery chiller that includes a refrigerant system (e.g., a compressor, a condenser, and/or an evaporator), a coolant system (e.g., a coolant pump and/or a heat exchanger), and/or a control system (e.g., a controller, one or more sensors, and/or one or more valves to monitor or control the refrigerant system and/or the coolant system). As another example, the cooling system 76A may include a radiator that includes a coolant system (e.g., a coolant pump and/or a heat exchanger), a dissipation system (e.g., a fan), and/or a control system (e.g., a controller, one or more sensors, and/or one or more valves to monitor or control the coolant system and/or the dissipation system).

The cooling systems 76A, 76B may be positioned within the enclosure 34 such that at least portions of the cooling systems 76A, 76B extend through the outlet vents 64A, 64B, respectively. For example, a fan housing 78A, containing a fan (e.g., for the dissipation system of the radiator), of the cooling system 76A may extend through the outlet vent 64A, while cooling system components 80A, 82A may reside within the enclosure 34. Cooling system components 80A, 82A may include components of the coolant system, the dissipation system (e.g., other than the fan), and/or the control system of the radiator, described herein. As another example, a fan housing 78B, containing a fan (e.g., for the condenser of the refrigerant system of the battery chiller), of the cooling system 76B may extend through the outlet vent 64B. In addition, cooling system component 80B may be positioned within the outlet vent 64B, while cooling system component 82B may reside within the enclosure 34. Cooling system components 80B, 82B may include components of the refrigerant system (e.g., other than a condenser fan), the coolant system, and/or the control system of the battery chiller, described herein. These configurations of the cooling systems 76A, 76B enhances thermal efficiency while also providing clear air flow paths through the enclosure 34. In some implementations, the first cooling system 76A may have the configuration described for the second cooling system 76B, and/or the second cooling system 76B may have the configuration described for the first cooling system 76A.

The first cooling system 76A may be configured to draw air through at least the first inlet vent 62A, and the second cooling system 76B may be configured to draw air through at least the second inlet vent 62B. The drawn air can be pulled over heat-generating components (e.g., the batteries 72, the electronics systems 74, etc.) to absorb thermal energy therefrom. The first cooling system 76A may be configured to expel heated air (e.g., exhaust) through the first outlet vent 64A, and the second cooling system 76B may be configured to expel heated air through the second outlet vent 64B in a flow direction (e.g., in the z-axis; away from the central wall 54). The covers 66A, 66B provide guiding of the air that flows through the outlet vents 64A, 64B, respectively, in the flow direction to flow through the openings 68A, 68B in a redirected flow direction (e.g., in the y-axis, along the central wall 54 and away from the operator station 36, such as towards a rear of the enclosure 34 or the machine 10). The redirection of the heated air can prevent the heated air from recirculating back into the inlet vents 64A, 64B, thereby improving thermal efficiency of the cooling systems 76A, 76B.

As the performance of the batteries 72 and of the electronics systems 74 is affected by their temperatures, the configuration of the ventilation system 50, that is, the enclosure 34 and the cooling systems 76A, 76B, can improve the performance of the machine 10 by efficiently handling heat exchange.

As indicated above, FIG. 5 is provided as an example. Other examples may differ from what is described with regard to FIG. 5.

### INDUSTRIAL APPLICABILITY

The ventilation system 50 described herein may be used with any enclosure that encloses a power source (e.g., one or more batteries, an engine, or the like), or another heat-generating component, of the machine 10. For example, the ventilation system 50 may be used with the enclosure 34 that encloses batteries 72 and/or an electronics system 74. The batteries 72 and/or the electronics system 74 electrify the propulsion and other functionality of the machine 10. In this way, the machine 10 is useful for low-emission operation in industries, such as mining, construction, farming, or transportation.

The batteries 72 and the electronics system 74 may generate a significant amount of heat, which can be dissipated through the cooling systems 76A, 76B. In a diesel machine, a radiator package may be positioned at the rear of an engine enclosure. However, in the machine 10, the batteries 72 may occupy this space at the rear of the enclosure 34. Thus, to avoid significantly increasing the overall length of the machine 10, the cooling systems 76A, 76B are located in an upper space of the enclosure 34 over the batteries 72 and the electronics system 74. In this configuration, hot air from the cooling systems 76A, 76B may be expelled straight upward, and is therefore susceptible to being recirculated into the enclosure 34, which can lead to overheating of the batteries 72 and the electronics system 74. Moreover, this configuration for the cooling systems 76A, 76B increases the risk of water entering the enclosure 34, which can result in electrical shorts or damage to the cooling systems 76A, 76B, batteries 72, or electronics system 74.

The air-guiding covers 66A, 66B described herein improve the thermal efficiency and water resistance of the enclosure 34. In particular, by guiding exhaust air from the cooling systems 76A, 76B along the surface of the enclosure 34 toward the rear of the machine 10, the covers 66A, 66B reduce the amount of hot air that is recirculated into the enclosure 34. In this way, the covers 66A, 66B facilitate efficient heat dissipation from the batteries 72 and the electronics system 74. Moreover, the covers 66A, 66B reduce water infiltration into the enclosure 34, thereby maintaining a suitable environment for sensitive electrical components. Furthermore, the covers 66A, 66B are configured to define sightline channels 70A, 70B that compensate for the large size of the enclosure 34 by providing viewing angles from the operator station 36.

The foregoing describes only some embodiments, and alterations, modifications, additions and/or changes can be made thereto without departing from the scope and spirit of the disclosed embodiments, the embodiments being illustrative and not restrictive. Furthermore, implementations are not limited to the disclosed embodiments, and may cover various modifications and equivalent arrangements included within the spirit and scope of the disclosed embodiments. Also, the various embodiments described above may be implemented in conjunction with other embodiments, for example, aspects of one embodiment may be combined with aspects of another embodiment to realize yet other embodiments. Further, each independent feature or component of any given assembly or process may constitute an additional embodiment. As used herein, the singular forms of “a,” “an,” and “the” include plural referents unless the context clearly dictates otherwise. In addition, as used herein, the term “or” means “and/or” unless the context clearly dictates otherwise.

Further, spatially relative terms, such as “upper,” “top,” “central,” “rear,” “left,” “right,” etc., may be used herein to describe one element or feature's relationship to another element(s) or feature(s) as illustrated in the figures. The spatially relative terms are intended to encompass different orientations in use or operation in addition to the orientation(s) depicted in the figures. Accordingly, the spatially relative terms may be interpreted in a corresponding manner to rotations of the orientation(s) depicted in the figures.

What is claimed is:

1. A work machine, comprising:
a frame;
a battery positioned on the frame;
an enclosure connected to the frame and enclosing the battery, the enclosure comprising:
a first side wall having an inlet vent through the first side wall;
a second side wall;
a central wall, extending between the first side wall and the second side wall, having an outlet vent through the central wall; and
an air-guiding cover over the outlet vent and defining an opening; and
a cooling system mounted to the enclosure over the battery, the cooling system configured to draw air through the inlet vent and expel air through the outlet vent in a flow direction, and the air-guiding cover configured to guide air that is to flow through the outlet vent in the flow direction to flow through the opening in a redirected flow direction.

2. The work machine of claim 1, wherein the opening and the outlet vent have approximately perpendicular orientations.

3. The work machine of claim 1, wherein the flow direction is away from the central wall, and the redirected flow direction is along the central wall.

4. The work machine of claim 1, further comprising an operator station supported on the frame,
wherein the redirected flow direction is away from the operator station.

5. The work machine of claim 1, wherein the air-guiding cover extends partially across the central wall to leave a first sightline channel defined between the air-guiding cover and a first edge of the central wall and a second sightline channel defined between the air-guiding cover and a second opposite edge of the central wall.

6. The work machine of claim 1, further comprising:
an electronics system electrically coupled to the battery,
wherein the enclosure encloses the battery and the electronics system; and
an additional cooling system mounted to the enclosure over the electronics system.

7. The work machine of claim 6, wherein the first side wall has an additional inlet vent through the first side wall,
wherein the central wall has an additional outlet vent through the central wall,
wherein the enclosure further comprises an additional air-guiding cover over the additional outlet vent that defines an additional opening, and
wherein the additional cooling system is configured to draw air through the additional inlet vent and expel air through the additional outlet vent in the flow direction.

8. The work machine of claim 7, wherein the additional air-guiding cover is configured to guide air flowing through the additional outlet vent in the flow direction through the opening in the redirected flow direction.

9. The work machine of claim 1, wherein the air-guiding cover has a sloping portion opposite the opening.

10. The work machine of claim 1, wherein the battery is one of a plurality of batteries positioned on the frame in the same orientation, and
wherein one or more first batteries, of the plurality of batteries, are elevated relative to one or more second batteries of the plurality of batteries with respect to the enclosure.

11. The work machine of claim 1, wherein the cooling system includes a fan and a heat exchanger.

12. An enclosure for a battery of a work machine, comprising:
a first side wall having an inlet vent through the first side wall;
a second side wall;
a central wall, extending between the first side wall and the second side wall, having an outlet vent through the central wall; and
an air-guiding cover over the outlet vent and defining an opening, the air-guiding cover configured to guide air that is to flow through the outlet vent to flow through the opening.

13. The enclosure of claim 12, wherein the opening and the outlet vent have approximately perpendicular orientations.

14. The enclosure of claim 12, wherein the second side wall has an additional inlet vent through the second side wall.

15. The enclosure of claim 12, wherein the central wall has an additional outlet vent through the central wall, and
wherein the enclosure further comprises an additional air-guiding cover over the additional outlet vent.

16. The enclosure of claim 15, wherein the air-guiding cover and the additional air-guiding cover are aligned such that air guided by the air-guiding cover is to flow over the additional air-guiding cover and combine with air guided by the additional air-guiding cover.

17. A ventilation system for a power source of a work machine, comprising:
an enclosure configured to enclose the power source, the enclosure comprising:
a wall having an outlet vent through the wall; and
an air-guiding cover over the outlet vent and defining an opening; and
a cooling system mounted to the enclosure, the cooling system configured to draw air through an inlet vent in the enclosure and expel air through the outlet vent in a flow direction, and the air-guiding cover configured to guide air that is to flow through the outlet vent in the flow direction to flow through the opening in a redirected flow direction.

18. The ventilation system of claim 17, wherein the opening and the outlet vent have approximately perpendicular orientations.

19. The ventilation system of claim 17, wherein the flow direction is away from the wall, and the redirected flow direction is along the wall.

20. The ventilation system of claim 17, wherein the air-guiding cover extends partially across the wall to leave a first sightline channel defined between the air-guiding cover and a first edge of the wall and a second sightline channel defined between the air-guiding cover and a second opposite edge of the wall.
